(19) United States
(12) Patent Application Publication
(10) Pub. No.: US 2015/0226245 A1
(43) Pub. Date: Aug. 13, 2015

(54) Elastic Band End Fastener Connecting Structure

(71) Applicant: Z Company, Diamond Bar, CA (US)

(72) Inventors: Andrew David Frankel, Yorba Linda, CA (US); Shi-Ping Zheng, Fuzhou (CN); Tian-Xia Zheng, Fuzhou (CN)

(73) Assignee: Z Company, Diamond Bar, CA (US)

(21) Appl. No.: 14/176,050

(22) Filed: Feb. 8, 2014

(51) Int. Cl. F16B 2/20

(52) U.S. Cl. CPC F16B 2/20

(57) ABSTRACT

The present invention relates to an elastic band end fastener connecting structure, including an elastic band and a fastener, wherein the fastener includes a clamping piece and a ring buckle. A section of the said clamping piece has a C-shaped structure. Flattened clamping piece can hold both ends of the folded elastic band to form a first end connecting structure. The folding point in the middle of the elastic band forms a second end. The ring buckle is bent into a rectangular shape by steel wire. Both ends of the steel wire are mutually staggered in the center of the rectangle, so as to form staggered gap, to reach the folding point of the elastic band with the aid of the staggered gap, and to form a second end connecting structure of the elastic band. The present invention provides the clamping piece and ring buckle with a simple structure, that facilitates tying or affixing the elastic band to a preset fixed ring of an object, and that simplifies the assembly process, and reduces the maintenance cost.

### BACKGROUND OF THE INVENTION

1. Technical Field

The present utility model relates to an elastic band end fastener connecting structure, which can especially be used to facilitate affixing an elastic band to an object or to hang the elastic band on an object, and tightening the elastic band to form a force bearing support.

2. Background Art

Elastic bands have very diverse application fields, for example, they can be used in an elastic chair with elastic bands as the seat surface, or on elastic hammock or trampoline, etc. It is necessary to firmly fix both ends of the elastic band, especially for an elastic chair, as well as to ensure production efficiency. As the seat and backrest of a chair, the elastic band is characterized by good air permeability and elasticity, but also suffers from some weakness. For example, the joints cannot be stitched using a sewing machine, and broken threads easily arises from the embedded rubber thread, which affects not only the beauty, but also elastic effect.

A traditional seat surface is strung and woven with an elastic band back and forth, with only a need to tie off and affix both ends. Once a chair is inoperable due to a broken rubber thread somewhere, it is necessary to change the entire seat surface with a resultant high renovation cost. Therefore, operators have correspondingly improved the seat surface made of elastic band. For example, CN2847988Y discloses an elastic rope strip nylon buckle connecting structure, which comprises an elastic band and two nylon buckles which are arranged relative to each other, wherein the nylon buckles form a frame shape. The top frame surface is provided with an opening and a through hole arranged on the bottom surface. The elastic band is positioned between the two nylon buckles, and the two ends are respectively connected with nylon buckles. The outer side of either nylon buckle is provided with a connecting support ear for affixing on a chair frame, with a connecting hole arranged on the support ear. A plurality of elastic bands are arranged on supporting beams of the chair frame side by side and both ends of the nylon buckles are directly fixed on the chair frame to form a complete seat surface. This prior patent provides a solution for fixing the elastic band, but still does not perfectly solve the problem of production efficiency: Firstly, it is necessary to fix nylon buckles to both ends of the elastic band in more complex assembly process; secondly, when the elastic band is fixed on the chair frame, it is necessary to lock more than two screws, which also have the weakness of tending to come loose.

### SUMMARY OF THE INVENTION

The present invention provides a improved design for an elastic band end fastener connecting structure, where the fastener includes a clamping piece and a ring buckle, and where the clamping piece holds the first end of the elastic band to form an end that can be limited by an object. The matched ring buckle facilitates going through the folding point formed while folding the elastic band during assembly, so as to realize limiting the other end of the elastic band by an object.

The technical scheme in the present invention is realized as follows: an elastic band end fastener connecting structure comprises an elastic band and a fastener, wherein the fastener includes a clamping piece and a ring buckle; section of the said clamping piece has a C-shaped structure, flattened clamping piece can hold both ends of the elastic band to form a first end connecting structure, and the folding point in the middle of the elastic band forms a second end; the ring buckle is bent into a rectangular shape by steel wire, both ends of the steel wire are mutually staggered in the center of the rectangle, so as to form staggered gap, reach the folding point of the elastic band with the aid of the staggered gap, and form a second end connecting structure of the elastic band. During assembly, the second end of the said elastic band successively goes through the first fixed ring and second fixed ring of an object, and the first end of the elastic band against the clamping piece is limited by the first fixed ring to form a force bearing support; the said ring buckle enters the second end of the elastic band with the use of the staggered gap, and the ring buckle is rotated, so that the corresponding side of the staggered gap is placed on the folding point of the second end, and forms a force bearing support. The ring buckle turns over around the folding point, so that the staggered gap clings to the surface of the elastic band, then both staggered ends of the ring buckle are respectively hidden in the folded elastic band.

The clamping piece with a C-shaped structure is made of a sheet metal by stamping forming or the like, and has a planar section and a bending section. The end of the bending section is folded in with anti-sliding teeth.

Anti-sliding teeth are arranged on one side of the bending section of the said clamping piece. A baffle plate is arranged on the extension on one side of the planar section of the said clamping piece. It can collide with the surface of the fixed elastic band object, and coincides with the surface of this object. A small circular structure is arranged on the bend on either end of the ring buckle.

The present invention provides the clamping piece and ring buckle with a simple structure, which facilitates tying or fixing the elastic band to a preset fixed ring of an object, simplifies the assembly process and reduces the maintenance cost. Flattening both ends of the clamped and folded elastic band with the clamping piece forms a first end, and the folding point of the elastic band forms a second end. During assembly, the second end of the elastic band successively goes through two fixed rings of an object, and then the ring buckle is buckled on the second end of the folding point of the elastic band, thus the elastic band assembly process is completed with high assembly efficiency.

### BRIEF DESCRIPTION OF THE DRAWINGS

This utility model is further illustrated with specific figures as follows:

FIG. 1 is a 3D front view of the clamping piece.

FIG. 2 is a 3D back view of the clamping piece.

FIG. 3 is a 3D schematic view of the ring buckle.

FIG. 4 is a Schematic diagram of the relationship between elasticity and fastener.

FIG. 5 is a Schematic diagram of the ring buckle buckled into the elastic band.

FIG. 6 is a Local view of the back of the backrest of a chair.

FIG. 7 is a Local view of the front of the backrest of a chair.

Where, the following reference numerals are used:
1—Elastic band
11—First end
12—Second end
2—Clamping piece
21—Planar section
22—Bending section
23—Anti-sliding teeth
24—Baffle plate
3—Ring buckle
31—Staggered gap
32—Small circle
4—Backrest rod
41—First fixed ring
42—Second fixed ring

### DETAILED DESCRIPTION OF THE INVENTION

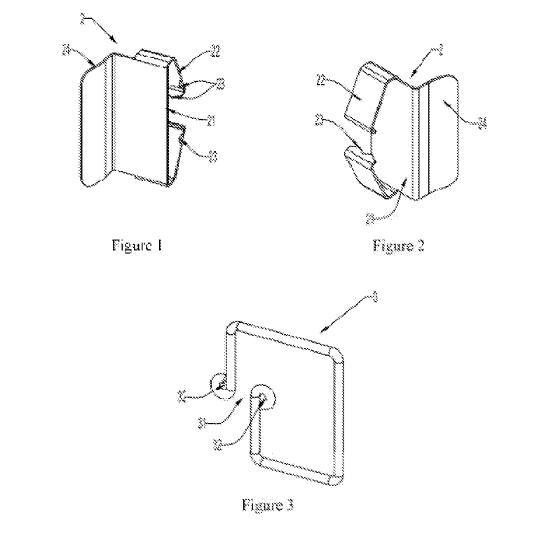

In FIGS. 1˜5, an elastic band end fastener connecting structure comprises an elastic band 1 and a fastener, wherein the fastener includes a clamping piece 2 and a ring buckle 3. Section of the said clamping piece 2 has a C-shaped structure. More specifically, the clamping piece 2 with a C-shaped structure is made of metal sheet through stamping forming or the like, and has a planar section 21 and a bending section 22. The end of the bending section 22 is folded inwardly with anti-sliding teeth 23. Anti-sliding teeth 23 are also arranged on one side of the bending section 22 of the clamping piece. When the bending section 22 of the clamping piece 2 flattens the elastic band fixed through clamping towards the planar section 21, it can be embedded into the body of the elastic band 1 with the use of the anti-sliding teeth 23 to form a reliable fixed structure and prevent the elastic band 1 from separating from the clamping piece 2 when stretched under force. Additionally, a baffle plate 24 is arranged on the extension on one side of the planar section 21 of the clamping piece 2, which can collide with the surface of the fixed elastic band object, and which coincides with the surface of this object. Structure of the clamping piece 2 is shown in FIG. 1 and FIG. 2.

As can be seen from FIG. 3, the ring buckle 3 is bent into a rectangular shape by steel wire, where both ends of the steel wire are mutually staggered in the center of the rectangle, so as to form staggered gap 31. The staggered gap 31 is very small as long as it can be large enough for the elastic band 1 to enter, of course including the structure without a gap between both staggered ends. When the elastic band 1 enters such structure, it is necessary to press the end of the ring buckle 3, causing it to have an elastic deformation, so that the elastic band can enter, and the assembly is relatively difficult. Either end of the ring buckle 3 is bent with a small circular structure 32. Both small circles 32 are arranged back to back, so as to ensure that the staggered gap 31 is smooth and complete, and to prevent the sharp steel wire end from cutting the elastic band.

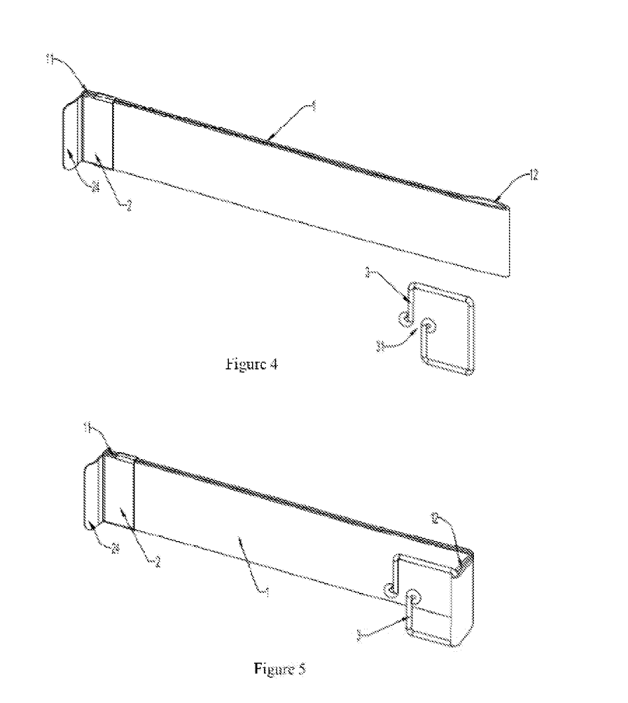

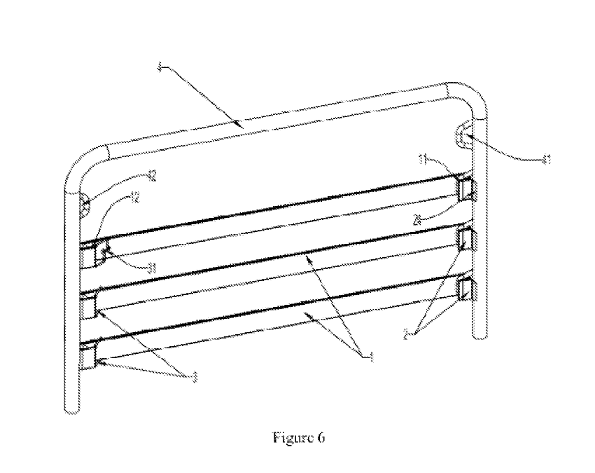

As can be seen from the connection relation between the elastic band 1 and the fastener in FIG. 4 and FIG. 5, the elastic band 1 is folded, and both folded ends of it are affixed with the aid of the clamping piece 2. More specifically, both folded ends of the elastic band 1 cling to the planar section 21 of the clamping piece 2, after it is inserted in place, the bending section 22 is flattened towards the planar section 21, affixes the end of the elastic band 1 through clamping, and strengthens the firmness of the combination between both with the use of the anti-sliding teeth 23. Both ends of the above folded elastic band 1 are clamped by the clamping piece 2 to form the connecting structure of the first end 11. The folding point in the middle of the elastic band 1 forms the second end 12. In FIG. 4, the ring buckle 3 is used only when assembling elastic band on an object. During assembly of the ring buckle 3 in FIG. 5, it is possible to enter the folding point of the elastic band 1 with the use of the staggered gap 31 and to rotate the ring buckle 3, so that the corresponding side of the staggered gap is buckled on the folding point of the elastic band 1 to form the connecting structure of the second end 12.

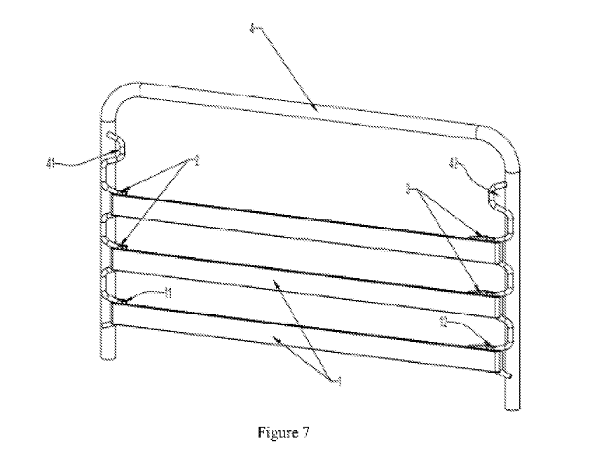

According to the backrest of the chair shown in FIG. 6 and FIG. 7, and in combination with FIG. 5, the backrest rod needs to be fixed on corresponding side of the elastic band 1, on which there is a pre-welded fixed ring. In order to simplify the description, fixed rings on both corresponding sides are respectively defined as the first fixed ring 41 and the second fixed ring 42. During assembly, the second end 12 of the elastic band 1 with a clamping piece 2 affixed through clamping on the first end 11 in above FIG. 4 successively goes through the object, that is, successively goes through the first fixed ring 41 and the second fixed ring 42 of the backrest rod 4. The first end 11 of the elastic band clinging to the clamping piece 2 is limited by the first fixed ring 11. The clamping piece 2 and the ring buckle 3 are wider than the fixed ring, and can be limited by the fixed ring as a consequence to form a force bearing support. During assembly of the ring buckle 3, the ring buckle 3 enters the second end 12 of the elastic band with the use of the staggered gap 31, and then the ring buckle 3 is rotated, so that the corresponding side of the staggered gap 31 is on the folding point of the second end 12 to form a force bearing support. Measures for further collection of the ring buckle 3 are provided below: The ring buckle 3 turns over around the folding point, so that the staggered gap 31 clings to the surface of the elastic band 1, then both staggered ends of the ring buckle 3 are respectively hidden in the folded elastic band 1. When the elastic band 1 is tightened, the clamping piece 2 on its first end 11 can also uniformly collide with the surface of the backrest rod 4 against the baffle plate 24 in order, which is clean and beautiful no matter whether seen from the front or back of the backrest.

Objects involved in the present invention include not only the above backrest of chairs, but also seat cushions of chairs, support of deck chairs, and objects which need to tighten and affix their elastic band, such as hammocks and trampolines, etc.; and the elastic band involved in the present utility model also generally refers to bands with deformation under elastic stretch such as elastic cord and trampoline band, etc.

We claim:

1. An elastic band end fastener connecting structure, including an elastic band and a fastener, wherein the fastener includes a clamping piece and a ring buckle; section of the said clamping piece has a C-shaped structure, flattened clamping piece can hold both ends of the folded elastic band to form a first end connecting structure, and the folding point in the middle of the elastic band forms a second end; the said ring buckle is bent into a rectangular shape by steel wire, both ends of the steel wire are mutually staggered in the center of the rectangle, so as to form staggered gap, reach the folding point of the elastic band with the aid of the staggered gap, and form a second end connecting structure of the elastic band.

2. An elastic band end fastener connecting structure defined in claim 1, characterized in that, the clamping piece has a C-shaped structure made of sheet metal through stamping forming, and has a planar section and a bending section. The end of the bending section is infolded with anti-sliding teeth.

3. An elastic band end fastener connecting structure defined in claim 2, characterized in that, anti-sliding teeth are arranged on one side of the bending section of the clamping piece.

4. An elastic band end fastener connecting structure defined in claim 2, characterized in that, a baffle plate is arranged on the extension on one side of the planar section of the clamping piece, which can collide with the surface of the fixed elastic band object, and coincide with the surface of this object.

5. An elastic band end fastener connecting structure defined in claim 1, characterized in that, a small circular structure is arranged on the bend on either end of the ring buckle.
